(19) United States
(12) Patent Application Publication
(10) Pub. No.: US 2025/0342810 A1
(43) Pub. Date: Nov. 6, 2025

(54) Electric Guitar Pickup Selection Method and Device Therefor

(71) Applicant: Min Ho Jin, Suwon-si (KR)

(72) Inventor: Min Ho Jin, Suwon-si (KR)

(21) Appl. No.: 19/267,514

(22) Filed: Jul. 12, 2025

Related U.S. Application Data
(63) Continuation of application No. PCT/KR2024/000520, filed on Jan. 11, 2024.

(30) Foreign Application Priority Data
Jan. 22, 2023 (KR) 10-2023-0009131

(51) Int. Cl. G10H 3/18

(52) U.S. Cl. CPC G10H 3/183; G10H 3/181

(57) ABSTRACT

The invention relates to an improved pickup selector for electric guitars, designed to allow players to switch one or more pickups effortlessly without altering their playing position. The device operates with a low-profile lever that moves parallel to the upper surface of the electric guitar, integrating seamlessly with the pickup holder for non-invasive installation. It includes a power-saving mechanism that disconnects inactive pickups, extending battery life. The synchronized switching system ensures noise-free operation, enhancing the overall player experience. This invention addresses usability, energy efficiency, and manufacturing simplicity for modern electric guitars.

### CROSS-REFERENCE TO RELATED APPLICATIONS

This application is a continuation of International Application No. PCT/KR2024/000520, filed on Jan. 11, 2024, which claims priority to Korean Patent Application No. 10-2023-0009131, filed on Jan. 22, 2023. The contents of the aforementioned applications are incorporated herein by reference in their entirety.

### BACKGROUND OF THE INVENTION

An electric guitar operates by converting string vibrations into electrical signals via pickups, amplifying these signals, and driving one or more speakers. To achieve a variety of tonal characteristics (voicing), one or more such pickups are mounted beneath the strings. A pickup selector is then used to determine which pickup signals are transmitted to the amplifier.

Conventionally, the pickup selector is primarily a switching circuit used to select the pickups that will contribute to the output. These selectors are generally configured as 3-way rotary switches, as shown in FIG. 3A, or 5-way rotary switches, as shown in FIG. 3B, and typically comprise a switching portion and an operating lever. To change the configuration of pickups for transmission to the output, players typically grasp and move the lever of the pickup selector. The lever must be sufficiently large for tactile manipulation and stable control. Furthermore, the device must possess sufficient durability to withstand the forces applied during operation. Consequently, the electric guitar body is processed to secure adequate space for the pickup selector, and its switching component is embedded within the electric guitar body, with the lever of the pickup selector protruding perpendicularly from the upper surface of the electric guitar body, often for design integration and improved player ergonomics.

However, despite these ergonomic and design considerations, the protruding lever can still interfere with playing. As a result, to prevent interference with performance and accidental contact, the pickup selector is often located in a position that is less accessible during play. This poses a challenge: if a player needs to operate the pickup selector during a performance, they must move their hand from the playing position to the pickup selector, operate it, and then return to the playing position. This movement makes quick operation difficult, potentially causing the player to inaccurately position the pickup selector lever or resulting in time delays that disrupt the performance. Traditionally, this has been considered an issue that players must overcome by improving their playing skills.

Electric guitar pickups are classified into active pickups, which require a battery, and passive pickups, which do not. Conventional pickup selectors, as shown in FIG. 3A and FIG. 3B, are designed to perform only the basic function of selecting pickups that contribute to the output signal. While some conventional systems implement basic power-saving by supplying power to all active pickups only when the electric guitar cable is connected to the output jack and completely cutting off power when the cable is disconnected, this method fails to address the continuous power drain by inactive active pickups during actual play. For example, in an electric guitar equipped with three active pickups, even if only the signal from one active pickup is outputted, the other two active pickups continuously consume battery power despite their signals not being outputted, significantly shortening battery life.

However, a separate issue frequently leads to unexpected battery drain. Even with these power-saving designs, players often forget to disconnect the electric guitar cable after use, leaving the electric guitar connected or stored with the cable still plugged in. Furthermore, beginner guitarists may be unaware that battery power is only cut off when the cable is disconnected. Consequently, the battery frequently drains quickly when the electric guitar is left or stored with its cable connected.

### SUMMARY OF THE INVENTION

The present invention provides an improved pickup selector for electric guitars, offering significant enhancements in playability, power efficiency, and manufacturing simplicity. Key aspects of the invention include:

Effortless and Precise Operation: Enables players to operate the pickup selector lever quickly and accurately without altering their playing position.

Non-Interfering Design: Positions the low-profile lever parallel to the upper surface of the electric guitar and integrated with the pickup holder, preventing accidental operation and interference with playing.

Enhanced Energy Efficiency: Incorporates a power-saving mechanism that automatically disconnects power to unused active pickups, thereby significantly extending battery life and reducing the inconvenience of frequent battery replacements.

Noise-Free Switching: Employs a synchronized switching system that ensures noise-free operation by connecting power before the signal and disconnecting the signal before power.

Simplified Manufacturing and Design Freedom: Facilitates easier installation by eliminating the need for extensive electric guitar body processing for embedding and wiring, leading to reduced manufacturing costs, shortened production time, and greater design flexibility.

### BRIEF DESCRIPTION OF THE DRAWINGS

For a more complete understanding of the invention, reference is made to the following description and accompanying drawings, in which:

FIG. 1 is a preferred embodiment of the present invention;

FIG. 2 is a preferred embodiment of mounting a sliding-type pickup selector integrated with a pickup holder;

FIG. 3A is a diagram illustrating a conventional 3-way pickup selector (PRIOR ART);

FIG. 3B is a diagram illustrating a conventional 5-way pickup selector (PRIOR ART);

FIG. 4A is a diagram illustrating an embodiment of the sliding-type pickup selector;

FIG. 4B is a diagram illustrating an embodiment of the toggle-type pickup selector;

FIG. 4C is a diagram illustrating an embodiment of the rotary-type pickup selector; and

FIG. 5 is a diagram illustrating an embodiment of a 3-way pickup selector with a built-in power switch.

### DETAILED DESCRIPTION OF THE INVENTION

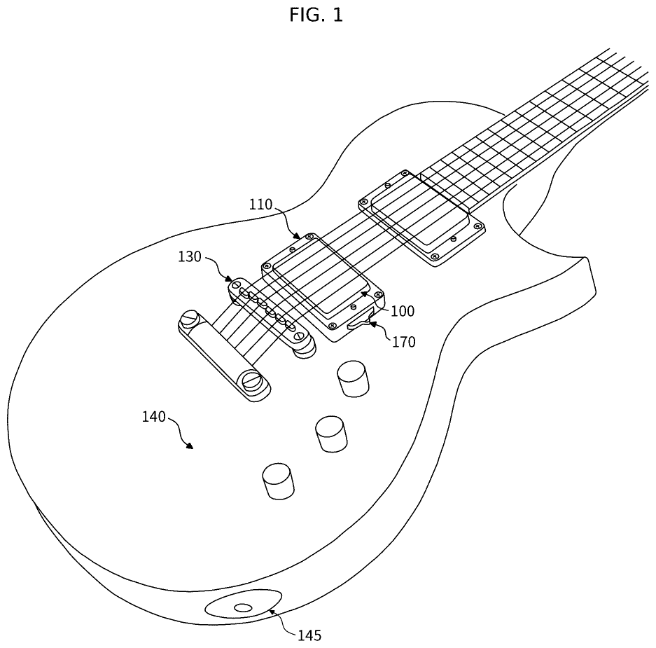

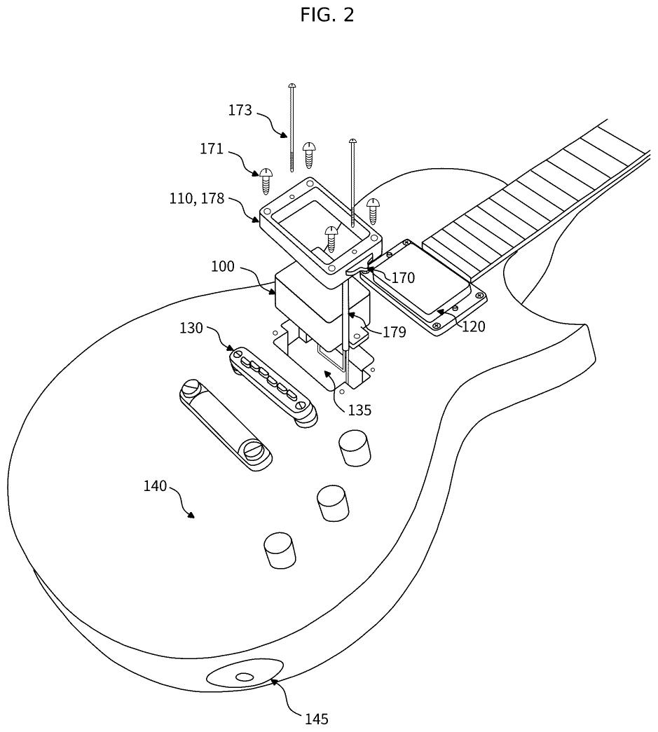

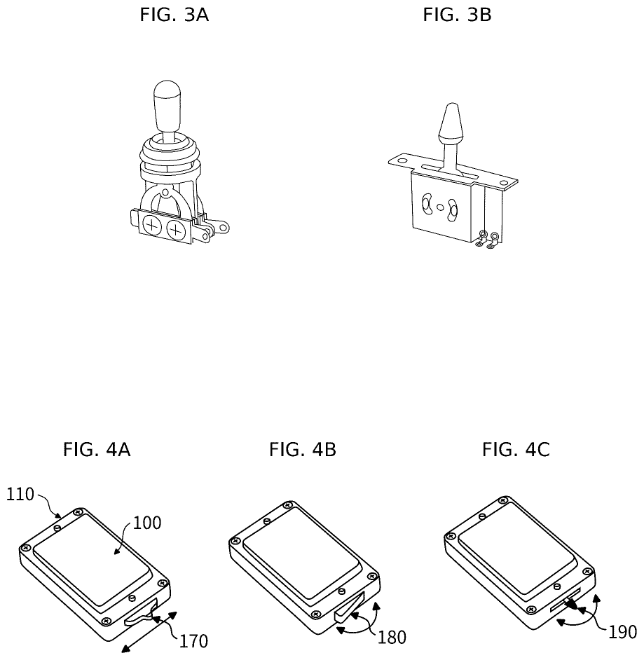

In one embodiment of the present invention, as illustrated in FIG. 1 and FIG. 4A, the pickup selector is integrated with the pickup holder 110 and strategically positioned within a region where the fingertips of the player naturally rest during playing. Typically, a player rests a part of the palm of their hand on the bridge 130 of the guitar during playing, and their pick-free ring, middle, and pinky fingers naturally rest perpendicularly below the bridge pickup 100 relative to the upper surface 140 of the electric guitar body, forming a natural space between the fingers and palm. The pickup selector is positioned in this space.

Positioning the pickup selector in this area presents several critical requirements: the pickup selector lever 170 must not interfere with playing by avoiding contact with the hand, it must resist unintentional changes even if accidentally touched, it needs to operate stably without electrical bouncing due to vibrations caused by the movement of the player's hand, and it must be easily operable with minimal force for intentional adjustments.

Conventional pickup selectors, with their switching units embedded by machining recesses in the electric guitar body and their levers protruding perpendicularly from the upper surface, often struggle to meet these requirements when placed close to the bridge pickup 100. This is due to space constraints for embedding the switching unit, making it difficult to position them within the hand of the player, causing the pickup selector lever to interfere with playing, and resulting in unintentional changes to the pickup selector lever. Consequently, it becomes challenging to position conventional pickup selectors effectively near the bridge pickup 100.

To overcome these issues, the pickup selector of the present invention, as shown in FIG. 1 and FIG. 4A, is designed to protrude above the upper surface 140 of the electric guitar body without being deeply embedded, thereby facilitating easy installation. The switching unit 175 of the pickup selector is built into the pickup holder 110, allowing the pickup holder 110 to serve as the body 178 of the pickup selector. The pickup selector lever 170 protrudes from a side of the pickup holder 110, which is perpendicular to the upper surface 140 of the electric guitar body and faces towards the ground during play, and is configured to move parallel to the upper surface 140. This design ensures the pickup selector lever 170 is very low in height-lower than the 1st string (the thinnest string of the electric guitar) and even lower than the height of the pickup holder 110. The pickup holder 110 thus effectively acts as a guard to prevent accidental contact during playing.

Furthermore, to ensure that the pickup selector lever 170 does not easily change unintentionally even if accidentally touched, it is designed to move parallel to the 1st string. This design leverages the player's hand movement, which typically traverses between the 6th and 1st strings (a direction perpendicular to the movement of the pickup selector lever 170), thereby preventing unintentional alteration of its switch state.

Additionally, by having the pickup selector lever 170 face towards the ground when the player plays the electric guitar, the player can operate it easily with a light curl of their fingertips without moving their hand, as the pickup selector lever 170 is directly positioned there. This eliminates the need for two-fingered operation, allowing for a more compact pickup selector lever 170 size, enabling its placement in a safer, less intrusive position within the hand of the player, further reducing the likelihood of accidental contact during playing.

Moreover, the player can ascertain the position of the pickup selector lever 170 by tactile sensation with their fingertips, which is often more desirable than visual confirmation during playing, especially in low-light conditions. This is facilitated by the movement of the pickup selector lever 170 along the protruding side of the pickup holder 110, allowing the player to quickly and easily ascertain the switch state through tactile feedback from the left and right margins of the pickup holder 110, avoiding the need to move their hand.

As illustrated in FIG. 2, the bridge pickup 100 is secured to the pickup holder 110, typically with a spring (not shown) on the pickup holding screw 173, allowing for height adjustment and stable fixing of the pickup within the holder. The pickup holder 110 is then fixed to the electric guitar body via pickup holder screws 171, after the pickup is embedded into the pre-machined recess 135 in the electric guitar body.

As demonstrated in this embodiment, the pickup selector is positioned closely to the bridge pickup 100. When the pickup holder 110, which also serves as the body 178 of the pickup selector including the pickup selector switching unit 175, is made to protrude from the upper surface 140 of the electric guitar, there is no need to machine a separate space for embedding the pickup selector. Furthermore, the wire 179 connection between the bridge pickup 100 (and other pickups like the neck pickup 120) and the pickup selector switching unit 175 can be directly made through the pre-machined recess 135, originally used for embedding the pickup into the electric guitar body, thereby eliminating the need for additional machining for wiring. In contrast, conventional pickup selectors require electric guitar manufacturers to machine and embed the pickup selector at a distance from the pickup, and then machine additional holes for wiring connections. Additionally, this embodiment, with the pickup holder 110 and pickup selector integrated as a single unit, offers an aesthetic advantage for the design of the electric guitar as the pickup selector is less conspicuous.

In another embodiment, FIG. 4B illustrates an integrated pickup selector and pickup holder 110 where the pickup selector lever 180 protrudes parallel to the upper surface 140 of the electric guitar body from one side of the pickup holder 110 which is perpendicular to the upper surface of the electric guitar. In this embodiment, the pickup selector lever 180 can be toggled left and right while in a parallel position relative to the upper surface 140 of the electric guitar body. This embodiment allows for easy operation of the pickup selector lever 180 with a fingertip touch and has the advantage of easily identifying the state of the pickup selector through the tilt of the pickup selector lever 180.

In another embodiment, FIG. 4C illustrates an integrated pickup selector and pickup holder 110 with a rotary type where the pickup selector lever 190 rotates parallel to the upper surface 140 of the electric guitar. Furthermore, in one embodiment of the present invention, it is also possible to implement the pickup selector closely to the pickup in electric guitars where the electric guitar pickup is directly attached to the electric guitar body without using a pickup holder 110.

The pickup selector levers 170, 180, and 190 of the present invention share the characteristic of being very low in height and facing downwards towards the ground. Although this design makes it difficult for the player to visually ascertain the current state of the pickup selector during playing, the player can readily ascertain the position of the pickup selector lever by tactile sensation with their fingertips, as described for pickup selector lever 170. Additionally, incorporating position marks, such as protrusions, on the body 178 of the pickup selector can further aid in identifying the switch state by allowing the player to determine the relative position of the pickup selector lever 170.

As described, the pickup selector of the present invention, designed for various operational modes including sliding, touching, and rotating, achieves its ergonomic benefits by being strategically positioned closely to the pickup, near the 1st string, and at a height lower than the 1st string. This design consistently prevents hand interference and facilitates quick, accurate adjustments without requiring the player to move their hand.

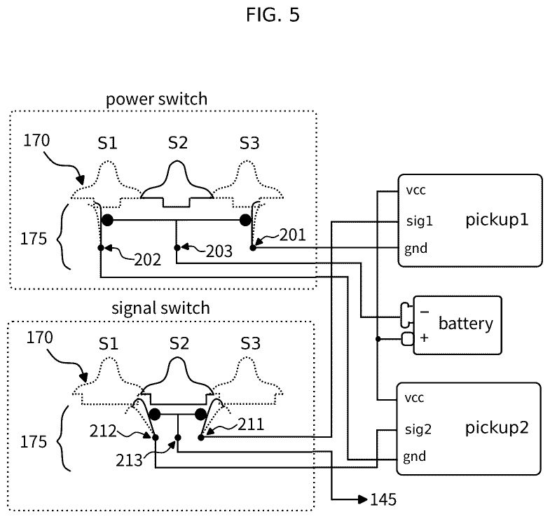

FIG. 5 illustrates a 3-way pickup selector, an exemplary embodiment for maximizing the battery life of active pickups. When the pickup selector lever 170 is operated, it selects the output pickup, thereby determining whether electrical signals (sig1, sig2) from one or more pickups are outputted to the electric guitar cable connector 145, which is connected to the out terminal 213 of the signal switch. This enables simultaneous power cut-off to pickups not contributing to the output from the pickup selector. Accordingly, the pickup selector incorporates a power switch for the pickups. The signal switch and the power switch of the pickup selector are designed to operate synchronously when the player manipulates the pickup selector lever 170. Furthermore, the design aims to prevent noise at the out terminal 213 of the signal switch due to power switch operation.

The present invention complements conventional electric guitar circuit systems to maximize battery life by minimizing power consumption. Conventional electric guitar circuit systems typically include a power switch embedded in the electric guitar cable connector 145, which applies power to all pickups when the electric guitar cable is connected and cuts off power when the electric guitar cable is disconnected. However, active electronic components like op-amps, which constitute active pickups, consume quiescent current for basic operation when power is applied. Furthermore, since batteries are not dual-supply (having both positive and negative polarities), active electronic components like op-amps must be configured with a single-ended supply (operating with positive and zero polarities), which consumes biasing current to provide a reference voltage for amplifying AC signals like electric guitar signals.

In the electric guitar circuit system, operating the pickup selector lever 170 to select an output pickup determines whether electrical signals from multiple pickups are outputted or not to the electric guitar cable connector 145. Pickups that do not contribute to the output from the pickup selector play no role in the electric guitar circuit, making it possible to cut off their power. Therefore, by individually cutting off power to pickups that are not contributing to the output, even when all pickups are powered via the electric guitar cable connector 145, quiescent current and biasing current consumption can be minimized. To achieve this, individual power switches for each pickup are added to the pickup selector in the existing electric guitar circuit system. It is preferable that the signal switch and the power switch of the pickup selector operate synchronously, with the power switch operation automatically aligning with the state of the signal switch when the player manipulates the pickup selector lever 170, thereby preventing the player from having to individually operate the power for each pickup. Care must also be taken to prevent noise from occurring due to the operation of the power switch.

To prevent noise, when connecting the power switch for the pickup and the signal switch for the pickup to output the electrical signal of a pickup whose power and electrical signal have been cut off, the power switch for the pickup is connected first, allowing the electrical circuit of the pickup to stabilize. Only then is the signal of the pickup connected and outputted. This sequence prevents noise caused by transient phenomena in the pickup's electrical circuit and the mechanical bouncing effect of the power switch for the pickup which can occur if the power switch for the pickup rapidly connects and disconnects for a short moment or if the electrical circuit operates unstably during the brief moment power is applied.

As illustrated in FIG. 5, the pickup selector in this embodiment consists of a pickup selector lever 170, which is the part the player actually operates, and a switching unit 175 directly or indirectly controlled by the lever. The power switch lever and the signal switch lever are configured to have geometrical features, such as different widths, to create a time difference in their contact during switching. Although the power switch lever and the signal switch lever are integrated into a single lever and move the same distance simultaneously, they are illustrated separately for explanation of their operation.

The 3-way pickup selector operates in three states: S1, which outputs only the electrical signal of pickup1 (sig1); S2, which outputs the electrical signals of both pickup1 and pickup2 (sig1, sig2) together; and S3, which outputs only the electrical signal of pickup2 (sig2). The positive (+) terminal of the battery is connected to the power terminals (vcc) of pickup1 and pickup2, and the negative (−) terminal of the battery to the out terminal 203 of the power switch. The ground terminal (gnd) of pickup1 is connected to the in1 terminal 201 of the power switch, and the ground terminal (gnd) of pickup2 is connected to the in2 terminal 202 of the power switch. The signal terminal sig1 of pickup1 is connected to the in1 terminal 211 of the signal switch, and the signal terminal sig2 of pickup2 is connected to the in2 terminal 212 of the signal switch. The output terminal out 213 of the signal switch is connected to the electric guitar cable connector 145. The in1 201 and in2 202 terminals of the power switch and the in1 211 and in2 212 terminals of the signal switch are conductive elements with resilience, and in the S2 state, they are connected to their respective out terminals 203, 213.

If the power switch lever and signal switch lever are simultaneously moved from the S2 state (where power is applied to pickup1 and pickup2, and both electrical signals are outputted) to the S1 state (where only the electrical signal of pickup1 is outputted), as the signal switch and power switch are designed with different contact widths for their respective terminals and corresponding lever widths, the in2 terminal 212 of the signal switch is immediately cut off. At this moment, the in2 terminal 202 of the power switch remains connected and is only cut off when both the power switch lever and the signal switch lever have fully moved to the S1 state. Therefore, the electrical signal of pickup2 is cut off before the power to pickup2, which prevents noise that could occur when the power to pickup2 is cut off.

Conversely, if the power switch lever and signal switch lever are in the S1 state and are moved to the S2 state to output the electrical signal of pickup2, the in2 terminal 202 of the power switch is connected due to the resilience of the in2 terminal 202 of the power switch, and power is applied to pickup2. At this time, the in2 terminal 212 of the signal switch for pickup2 remains cut off and is only connected when both the power switch lever and the signal switch lever have fully moved to the S2 state, at which point the electrical signal of pickup2 is outputted. Therefore, when both power and electrical signal of pickup2 have been cut off, power to pickup2 is applied first, and the electrical signal of pickup2 is connected and outputted later, which prevents noise caused by transient phenomena in the electrical circuit of pickup2 and the mechanical bouncing effect of the power switch's in2 terminal 202. The transition from the S2 state to the S3 state and the return from the S3 state to the S2 state similarly prevent noise when power is applied or cut off to pickup1.

While this embodiment prevents noise by using resilient conductive materials for the contact points of each switch position on the pickup selector and by varying the widths of the power switch lever and signal switch lever, various other methods can be applied to utilize the time difference in the operation of the power switch and signal switch.

For clarity in understanding the foregoing description, the following conventions apply to the terminology used: The terminology used in this disclosure is for describing particular embodiments only and is not intended to limit the present invention in any way. Singular terms should be understood to include plural forms unless the context clearly indicates otherwise. Terms such as “comprise,” “include,” or “have” are intended to be inclusive and not exclusive. Additionally, directional or positional terms such as “parallel” and “perpendicular” are used for ease of description and refer to relative orientations as understood by those skilled in the art, and are not to be construed as limiting unless explicitly stated. These terms should be interpreted in a reasonable manner consistent with the understanding of a person of ordinary skill in the art, and not in a strictly literal or idealized sense.

What is claimed is:

1. A pickup selector, comprising:
a pickup selector lever;
a pickup selector switching unit directly or indirectly controlled by the pickup selector lever; and
a body of the pickup selector including the pickup selector switching unit;
wherein the pickup selector switching unit and the body of the pickup selector protrude above the upper surface of an electric guitar body;
wherein the height of the pickup selector lever from the upper surface of the electric guitar body is lower than the height of the body of the pickup selector from the upper surface of the electric guitar body;
wherein the pickup selector lever protrudes from a side of the pickup selector body that protrudes above the upper surface of the electric guitar body, the side being perpendicular to the upper surface of the electric guitar body and facing downward toward the ground; and
wherein the pickup selector lever is configured to move in a direction substantially parallel to the upper surface of the electric guitar body.

2. The pickup selector of claim 1, wherein one or more wires for connecting the pickup selector switching unit and one or more pickups extend through a recess configured to embed the pickups within the electric guitar body.

3. The pickup selector of claim 2, wherein the body of the pickup selector is a pickup holder.

4. The pickup selector of claim 1, wherein the pickup selector lever is configured to move in a direction substantially parallel to strings of the electric guitar.

5. The pickup selector of claim 1, wherein the pickup selector switching unit comprises signal switches and power switches for one or more pickups;
wherein a signal of a pickup and power of the corresponding pickup are synchronously disconnected or connected by the pickup selector lever; and
wherein, when reconnecting a pickup for which power and signal have been disconnected, the power switch is connected prior to the signal switch.
